(19) United States
(12) Patent Application Publication
(10) Pub. No.: US 2002/0157506 A1
(43) Pub. Date: Oct. 31, 2002

(54) Flexible drive shaft

(76) Inventor: Robert L. Schade, Reedsburg, WI (US)

Correspondence Address: H. Keith Schoff, Attorney at Law, 2257 East Washington Avenue, Madison, WI, 53704, US

(21) Appl. No.: 09/844,323

(22) Filed: Apr. 30, 2001

(51) Int. Cl. B25B 23/16

(52) U.S. Cl. 81/177.6

(57) ABSTRACT

A flexible drive shaft extension for hand tools comprises serially nested, socket-ended shaft components of polygonal cross-section which have freedom of universal movement from axial alignment limited to about five degrees of arc and which are forcibly retained in coupled connection within a sleeve by spring biasing.

### FIELD OF INVENTION

A drive shaft imparts torque from a power source to machinery.

### BACKGROUND OF INVENTION

Flexible drive shafts are provided for utilizion with portable tools in spacially restricted locations which do not allow for use of one's hands or placement of a power source in a manner required for conventional operation of the tool.

### UMMARY OF THE INVENTION

Universal joints in serially connected assembly are known for use as articulated drive shafts for portable tools. Such assemblies are limited in utility by the strength of an enveloping sleeve to restrict articulation of the joints to a degree less than that which causes the sleeve to crimp or twist into helical contortion in response to torque applied to the the shaft.

The drive shaft of this invention provides a flexible elongated sleeve housing containing spring loaded, unconnected, abutting torque transmission elements. The configuration of each element provides for limited freedom of universal movement from axial alignment to occur between between conjoined elements. Preferably, such movement is limited to about five degrees of diviation from axial alignment, not to exceed about ten degrees. Such construction improves torque transmitting capacity of a drive shaft with lesser complexity than prior art means utilizing pinned or or interlocking connection between elements.

### BRIEF DESCRIPTION OF THE DRAWINGS

FIG. 1 is a cross-sectional elevation of a preferred embodiment of a flexsible drive shaft this invention shown in axially straight disposition.

FIG. 2 is a cross-sectional elevation of the apparatus of FIG. 1 shown in curvilinear axial disposition.

FIG. 3 is an enlarged view of one end portion of the drive shaft of FIGS. 1 and 2.

FIG. 4 is an isolated view of element 40 of FIG. 1.

### DESCRIPTION OF THE INVENTION

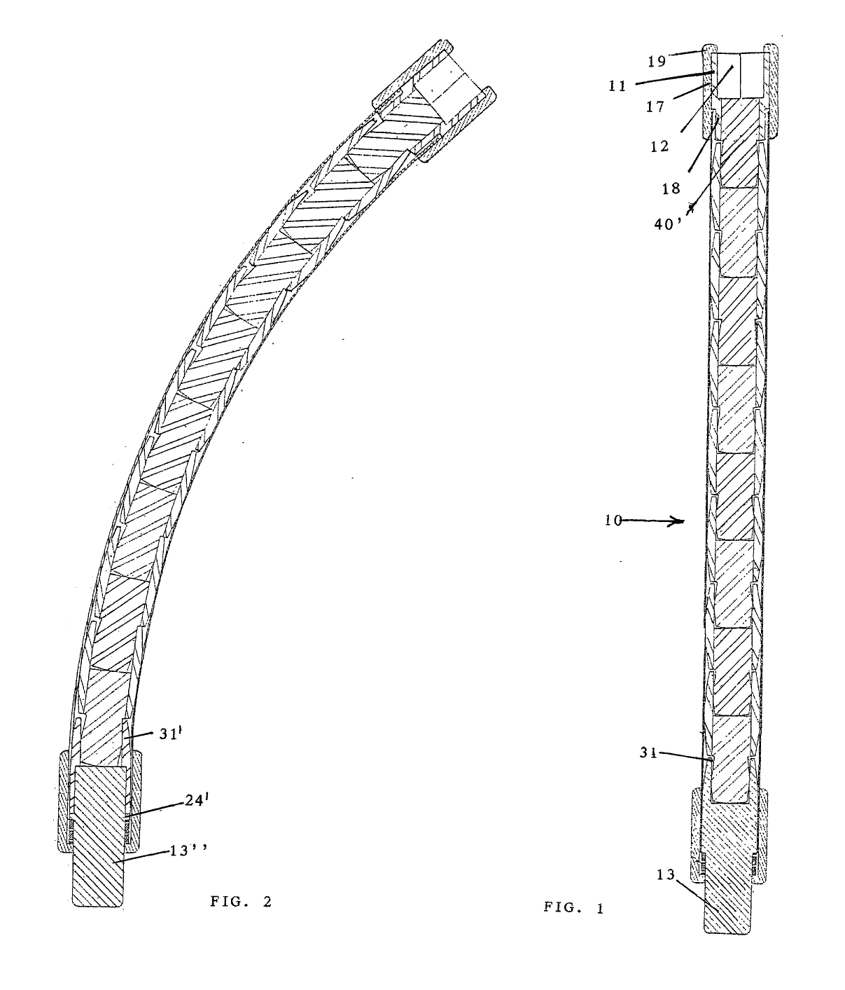

FIG. 1 depicts drive shaft 10 for use with, for example, hand tools such as manually operated ratchet drivers or compressed air driven impact tools. The drive shaft is usable with a wide range of other tools and machinery.

Driven element 11 at a first end of drive shaft 10 is operably connectable to a prime mover, not shown, by square distal end socket portion 12 of element 11 being, preferably, of standard face width dimension for such use, e.g. in the English system of measurement, ¼ inch, ⅜ inch, ½ inch, etc. for operably receiving a square shaft end of complementary size.

The remainder of driven element 11 comprises proximal end socket portion 18. The inner cross-sectional socket configuration may be any suitable polygonal cross-section, but preferably is hexagonal. The outer surface cross-sectional configuration is preferably round. Proximal end socket portion 18 is configured with inner and outer peripheral diameters reduced in size from those of distal end socket portion 12.

End cap 17 extends axially beyond distal end socket portion 12 with flange portion 19 thereof projecting radially inward to provide a bearing surface for slidable rotational contact with the face of distal end socket portion 12. Central opening 15 in end cap 17 enables endmost accessibilty into drive shaft 10 to be made by a shaft end of a prime mover or other power source.

At the opposite end of drive shaft 10, driver end element 13 is configured with cross-sectionally square distal end stud portion 14, which is complementary in size to distal end socket portion 12 of element 11. Any other operable configuration of end elements 11 and 13 may be utlized to accomodate other connecting means.

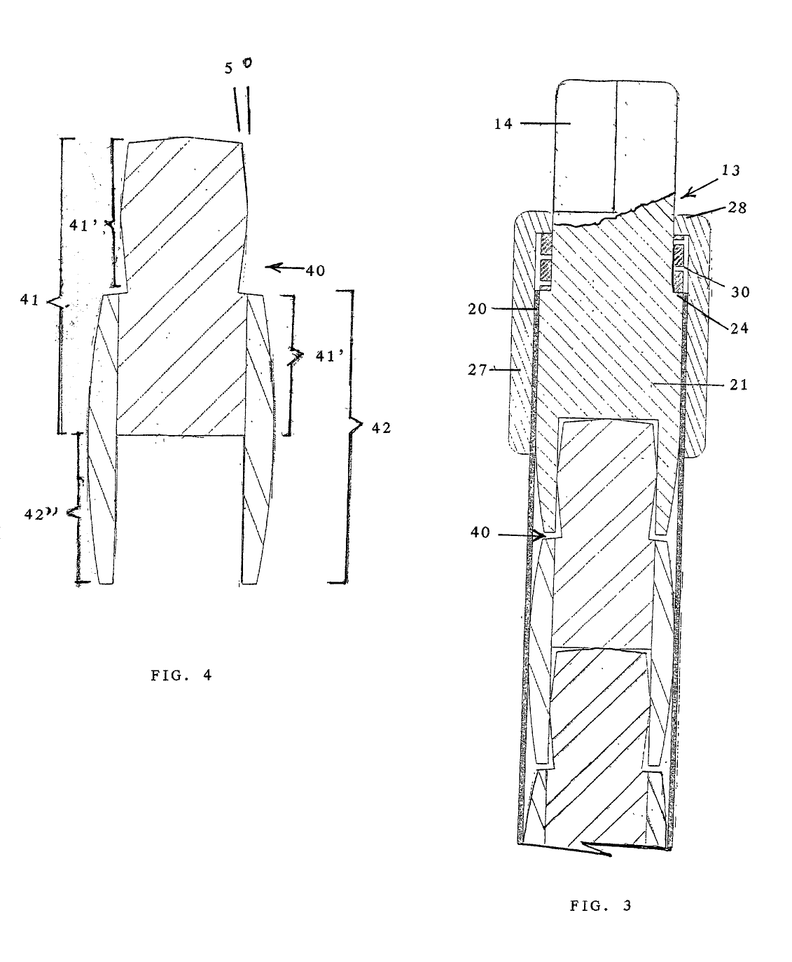

Proximal end portion 21 of driver end element 13 is preferably cross-sectionally round. In FIGS. 1 and 3, shoulder portion 24 of element 13 provides a stepped increase in the outer diameter of element 13 from which the surface assumes a truncated ellipsoidal form which decreases in diameter approximately ellipsoidally toward the proximal end face of element 13 with a tangent angle between the outer surface of element 13 at the proximal end to the longitudinal axis of element 13 being preferably about five degrees and not more than about ten degrees. Socket 30, which may be of any suitable polygonal cross-section, but preferably is hexagonal, opens to the proximal end of element 13, extending axially longitudinal in element 13.

End cap 27 is configured with radially inward extending, distal end face flange portion 28 disposed in sliding contact with the peripheral face of distal end portion 21 of element 13. End caps 17 and 27 retain assembly of drive shaft 10 intact.

Helical compression spring 30 is disposed peripherally around proximal end portion 21 of driver element 13 between shoulder 24 of element 13 and flange portion 28 of end cap 27.

Flexible sleeve 20 is fixedly secured to the inner peripheral surfaces of end caps 17 and 27. It is kept tautly drawn by tensioning action of spring 30 acting through tightly coupled nesting components of drive shaft 10 disposed intermediate the two ends of the shaft. Spring 30 forcibly bears on shoulder 24 of element 13 and flange portion 28 of end cap 27, and resiliently adjusts by operably expanding or contracting in response to curvilinear flexing of drive shaft 10 during use.

In the embodiment of invention of FIG. 2, driver end element 13′ differs from similar element 13 of FIGS. 1 and 3 by comprising two components, i.e. core piece 13″ and socket piece 31′. The two latter components are unitarily affixed to provide the same configuration as element 13 of FIGS. 1 and 3, but allows for alternative ways of manufacturing components, whether by forging, casting, machining, press fitting or other known processes. In FIG. 2 shoulder 24′ is configured as an integral band configured portion which increases the outer diameter of core piece 13″ for a short axial distance rather than providing a step in the configuration of the whole outer diameter as in the case of shoulder 24 of FIGS. 1 and 3. Correspondingly, socket piece 30′ of FIG. 2 while being a separate part is unitarily affixed to core piece 13″ to provide a resuting structure similar to element 13 of FIGS. 1 and 3.

Seven identical core elements 40 together with one non-identical core element 40′ comprise the remainer of components of drive shaft 10 shown in the FIGS. 1, 2, and 3. They are shown each to be of two-piece construction, and in all material ways are subject to similar choice of construction practice as shown for elements 13 and 13′ so as to be constructed either from one piece or from two pieces which are subsequently unitarily connected. Each core element 40 comprises unitary shank portion 41 and socket portion 42. Shank portion 41 (FIG. 4) is disposed with jacketed end portion 41′ encased unitarily in the base end of socket portion 42 and can either be of polygonal or circular cross-sectional interface configuration, or of other operable mating configuration as desired. Nesting end portion 41″ of shank portion 41, integral with end portion 41′, is configured with a polygonal cross-section, which may be of any operable shape, but preferably is regular hexagonal. From approximately the longitudinal axial mid-point of nesting end portion 41″ toward each axial end extremity of portion 41″ the planar faces of the peripheral polygonal surface of end portion 41′ each make an angle of preferably about five degrees with the longitudinal axis of core element 40 whereby end portion 41″ is of lesser diameter at each end than at the middle. In addition, it is preferred as shown in the drawings, but not required, that the end face of end portion 41″ be configured with planar segments disposed at an angle of approximately one hundred degrees to associated planar peripheral faces of portion 41″. The resulting configuration is one of providing a faceted protruding conical end to end portion 41″.

Socket portion 42 of core element 40 is in all material respects similar to socket piece 31′ of FIG. 2 with the exception that the inner peripheral face portion 42′ encasing peripheral portion 41′ is of uniform diameter rather than being of stepped diameter as it is for socket piece 31′. Instead of being affixed to core piece 13″ as in FIG. 2, socket portion 42′ is affixed to base portion 41′ of shank portion 41 to provide unitary core element 40. The outer peripheral surface of socket portion 42 is of circular cross-section and of ellipsoidal axially longitudinal section. The inner peripheral surface is of annular socket portion 42″ is of polygonal cross-section with regular hexagonal cross-sectional configuration being preferred. Socket portion 42″ inner diameter is such as to be complementary for operable receiving nesting end portion 41″ of shank portion 41 of a next adjacent core element 40. The depth of socket portion 42 is such that nesting end portion 41″ disposed within a socket will contact the bottom of the socket, i.e. the end face of base portion 41′ of element 40 with which it is nested, while the endmost extremities of socket portions 41′ of next adjacent core elements 40 are spacially separated when drive shaft 10 is disposed in straight as it is shown in FIG. 1. This configuration insures that core elements 40 are fully nested by action of compression spring 30 thereby insuring that axial deviation between next adjacent core elements 40 does not exceed intended design limitation, such as a preferred limitation of about five degrees herein suggested when drove shaft 10 is flexed as shown in FIG. 2.

Core element 40′ differs from core elements 40 in the Particular that the base portion 42′ of shank portion 41 is sized to be received in end socket portion 18 of driven element 11.

The provision of spring loading elements in nested joinder at all times during use serves to prevent excessive angular deviation between elements from occurring and resulting in failure of the drive shaft to perform satisfactorly for its intended use.

I claim:

1. A flexible drive shaft for portable tools, comprising in combination:
a) a flexible elongated housing comprising a sleeve, a first end cap and a second end cap affixed one each to opposite end portions of said sleeve, each said end cap being configured with a central opening to form with said sleeve an elongated structure with endmost interior accessibility for enabling intermediate connection to be made therethrough between a tool and a prime mover,
c) a plurality of torque transmission elements disposed in said housing in free, unconnected, tightly abutting, end-to-end axially nested arrangement, said elements being similarly configured with a polygonal cross-sectional shank end portion at one axial extremity and a polygonal cross-sectional socket end portion at the other axial extremity, wherein one said element cross-sectional shank end portion operable nests in a polygonal cross-sectional socket end portion of a next adjacent said element, with each said element having limited freedom of universal movement from axial alignment with a next adjacent said element, the endmost of said elements being configured one with a distal end portion configured for making operable connection to a prime mover and a second with a distal end portion configured for making operable connection for driving a tool,
d) resilient means disposed within said housing forcibly biasing all said elements into constant tightly abutting, nested disposition.

2. The apparatus of claim 1 wherein said torque transmission element cross-sectionally polygonal shank end portion faces, and outer peripheral socket end portion surface are arcuately configured longitudinally substantially as truncated elliptical surfaces for enabling limited freedom of universal movement from axial alignment between tightly abutted, nested, operably conjoined said elements throughout a range only of not more than subsdtantially ten degrees of angular displacement axial between next adjacent said elements.

3. The apparatus of claim 1 wherein said cross-sectional polygonal shank end portion and said polygonal socket end portion of said element are of hexagonal cross sections.

4. The apparatus of claim 1 wherein said resilient means comprises a compression spring.
